(19) United States
(12) Patent Application Publication
(10) Pub. No.: US 2026/0358548 A1
(43) Pub. Date: Nov. 12, 2026

(54) METHOD FOR MANUFACTURING A RAISED PATTERN AND RAISED PATTERN MANUFACTURED BY THIS METHOD

(71) Applicant: VALEO VISION, Bobigny (FR)

(72) Inventors: Eduardo ALVEAR, Bobigny (FR); Sidahmed BEDDAR, Bobigny (FR); Hafid EL-IDRISSI, Bobigny (FR); Benoit DELANDE, Bobigny (FR)

(73) Assignee: VALEO VISION, Bobigny (FR)

(21) Appl. No.: 19/135,169

(22) PCT Filed: Nov. 28, 2023
(86) PCT No.: PCT/EP2023/083441

§ 371 Date: Jun. 3, 2025

(30) Foreign Application Priority Data
Dec. 8, 2022 (FR) FR2212936

(51) Int. Cl. F21V 8/00; B44C 1/22

(52) U.S. Cl. CPC G02B 6/006; B44C 1/227

(57) ABSTRACT

One aspect of the invention relates to a method for manufacturing a raised pattern in a transparent film which is suitable for guiding light, the transparent film includes a first layer of a first transparent material, the method includes etching, in the first layer of transparent material, a pattern which is suitable for extracting the light guided inside the transparent film, insolating and/or polymerising the transparent film by ultraviolet radiation and forming the raised pattern in a region of the transparent film.

### TECHNICAL FIELD

The technical field of the invention is that of signaling and lighting.

The present invention relates to a method for manufacturing a raised pattern in a transparent film suitable for guiding light. Another subject of the invention is a raised pattern produced in a transparent film suitable for guiding light. The present invention also relates to a decorative structure comprising a raised pattern and a transparent film suitable for guiding light.

### BACKGROUND OF THE INVENTION

Transparent films suitable for guiding light are used in the field of signaling and lighting.

FIG. 1a illustrates an example of a transparent film used as a display screen according to the prior art. Such a device comprises a transparent film having a thickness of a few tens of micrometers, a light source coupled to one of the lateral faces of the transparent film and one or more micro-structured patterns etched into the upper face of the transparent film. The light emitted by the source propagates by total internal reflection inside the transparent film. The micro-structured patterns allow light to be extracted, which makes them visible from the outside. FIG. 1b illustrates one of the advantages of these devices, specifically their flexibility and their small size.

Other known advantages of lighting and signaling devices based on transparent films are their luminosity and their low energy consumption. These devices make it possible to obtain a high contrast even in the daytime.

It is desired to create raised patterns in a transparent film suitable for guiding light.

### SUMMARY OF THE INVENTION

The invention provides a solution to the abovementioned problems by describing a method for manufacturing a raised pattern in a transparent film suitable for guiding light.

One aspect of the invention relates to a method for manufacturing a raised pattern with a transparent film suitable for guiding light, said transparent film comprising a first layer of a first transparent material, the method comprising the following steps:
etching, into the first layer of transparent material, a pattern suitable for extracting the light guided inside the transparent film,
exposure and/or polymerization of the transparent film using ultraviolet radiation,
forming the raised pattern in a zone of the transparent film.

The invention makes it possible to combine etched patterns, specifically patterns illuminated by the light guided in the transparent film, and raised patterns. In other words, the invention makes it possible to obtain patterns that are both raised and illuminated.

The invention makes it possible to obtain logos or decorative structures or light signatures that are both three-dimensional or raised and illuminated.

A transparent film suitable for guiding light is understood to mean a film allowing the light to be confined by total internal reflection.

Etching, into the first layer of the transparent material, a pattern suitable for extracting the light guided inside the transparent film is understood to mean the formation of a structured pattern on the upper face of the transparent film. The etching may be carried out, for example, by optical lithography.

Exposure of the transparent film using ultraviolet radiation is understood to mean illuminating the film so as to fix the pattern to be etched in order to print the pattern.

Forming the raised pattern is understood to mean deforming the transparent film suitable for guiding light in order to obtain the desired raised pattern. This is possible by virtue of the high flexibility of the transparent film used to guide light, which allows the film to adhere to a mold, for example during the formation of the raised pattern by thermoforming.

The invention makes it possible to obtain illuminated three-dimensional structures with high contrast and luminosity even in the daytime, while at the same time maintaining low energy consumption.

The invention makes it possible to obtain structures that are both flexible and lightweight.

Advantageously, the step of forming the raised pattern is a step of three-dimensionally forming the transparent film.

Advantageously, the step of forming the raised pattern is a step of thermoforming the transparent film; the thermoforming step enables a three-dimensional pattern to be produced in a simple and reproducible manner.

The step of forming the raised pattern is carried out by pressing on the transparent film; advantageously, the forming under pressure enables better precision in terms of molding the details.

Advantageously, the raised pattern is a logo or a light signature or a decorative pattern.

Advantageously, the step of exposure of the transparent film using ultraviolet radiation comprises a step of polymerization of the transparent film; the polymerization of the transparent film makes it possible to fix in place the pattern suitable for extracting the light.

Advantageously, the method according to the invention further comprises a step of producing reference marks in the transparent film, the reference marks being suitable for positioning the pattern suitable for extracting the light with respect to the raised pattern; the reference marks enable the illuminated pattern to be precisely positioned with respect to the three-dimensional pattern, so as to obtain the desired effect.

Advantageously, the transparent film comprises an integer number N greater than or equal to 1 of layers of transparent material superposed with the first layer of the first transparent material, the method comprising, before the step of exposure of the transparent film, a step of etching at least one other pattern than in the first layer into at least one of the N layers of transparent material; this step makes it possible to obtain a plurality of patterns illuminated by the light.

A second aspect of the invention relates to a raised pattern obtained according to the method having at least one of the preceding features.

A third aspect of the invention relates to a decorative structure that can be illuminated, comprising:
1. a raised pattern obtained by means of the method having at least one of the preceding features,
2. a light guide comprising a first layer of a transparent material,
3. a light source for illuminating the light guide,
the light guide being positioned so as to guide rays originating from the light source into the first layer of transparent material and to illuminate the etched pattern.

According to one embodiment, the decorative structure further comprises:
1. N other light guides,
2. N other light sources for illuminating each of the N light guides, the N light sources emitting in different spectral regions,
the N other light guides being positioned so as to guide rays originating from one of the N other illumination light sources into a corresponding layer from among N layers of transparent material and to illuminate at least one other pattern.

These features make it possible to obtain a plurality of patterns illuminated by the light, each pattern having a different color.

The invention and the various applications thereof will be understood more clearly from reading the following description and studying the accompanying figures.

### BRIEF DESCRIPTION OF DRAWINGS

The figures are presented by way of indication and in no way limit the invention.

FIGS. 1a and 1b illustrate an example of a display screen according to the prior art;

FIG. 2 illustrates the method for manufacturing a raised pattern according to the invention;

FIG. 3 illustrates an example of a raised pattern according to the invention; and

FIG. 4 illustrates an example of a transparent film suitable for guiding light comprising a plurality of layers of a transparent material.

### DETAILED DESCRIPTION OF THE INVENTION

The figures are presented by way of indication and in no way limit the invention.

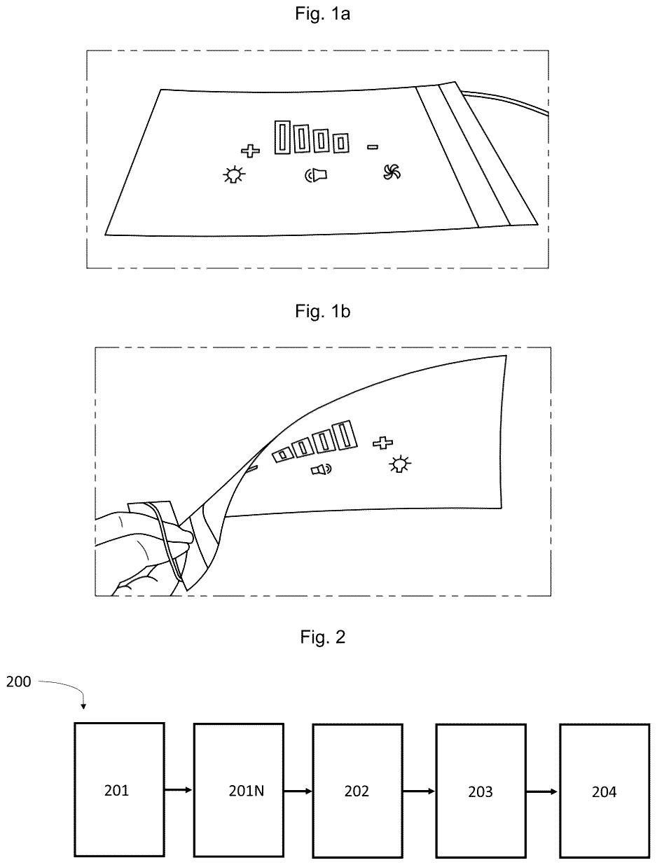

FIG. 1a and FIG. 1b illustrate a display screen comprising a transparent film suitable for guiding light according to the prior art. FIG. 1a and FIG. 1b have been described in relation to the prior art.

FIG. 2 illustrates the method 200 for manufacturing a raised pattern in a transparent film suitable for guiding light according to the invention. The transparent film comprises a first layer of a first transparent material.

The method 200 according to the invention comprises a step 201 of etching, into the first layer of transparent material, a pattern suitable for extracting the light guided inside the transparent film. This step makes it possible to define the shape of the patterns illuminated by the light propagating inside the transparent film. According to one embodiment, the etching step 201 is a micro-etching step.

The method 200 according to the invention further comprises a step 202 of exposure of the transparent film using ultraviolet radiation. This step makes it possible to fix in place the patterns etched in step 201. According to one embodiment, the exposure step 201 further comprises a step of polymerization of the transparent film.

According to one embodiment, the method 200 according to the invention further comprises a step 203 of producing reference marks in the transparent film, the reference marks being configured to position the pattern suitable for extracting the light with respect to the raised pattern. This step makes it possible to precisely align the raised pattern and the illuminated pattern so as to be able to obtain the desired effect.

The method 200 according to the invention further comprises a step 204 of forming the raised pattern in a zone of the transparent film.

According to one embodiment, the step 204 of forming the raised pattern is a step of thermoforming the transparent film. By virtue of its flexibility, the transparent film can adhere to a mold during the thermoforming step.

According to another embodiment, the step 204 of forming the raised pattern is carried out by pressing on the transparent film.

According to one embodiment of the method 200 according to the invention, the transparent film comprises an integer number N greater than or equal to 1 of layers of transparent material superposed with the first layer of the first transparent material. In this case, the method 200 comprises, before the step of exposure of the transparent film, a step of etching 201N at least one other pattern into at least one of the N layers of transparent material.

According to this embodiment, it is possible to obtain a raised pattern comprising a plurality of independent illuminated patterns.

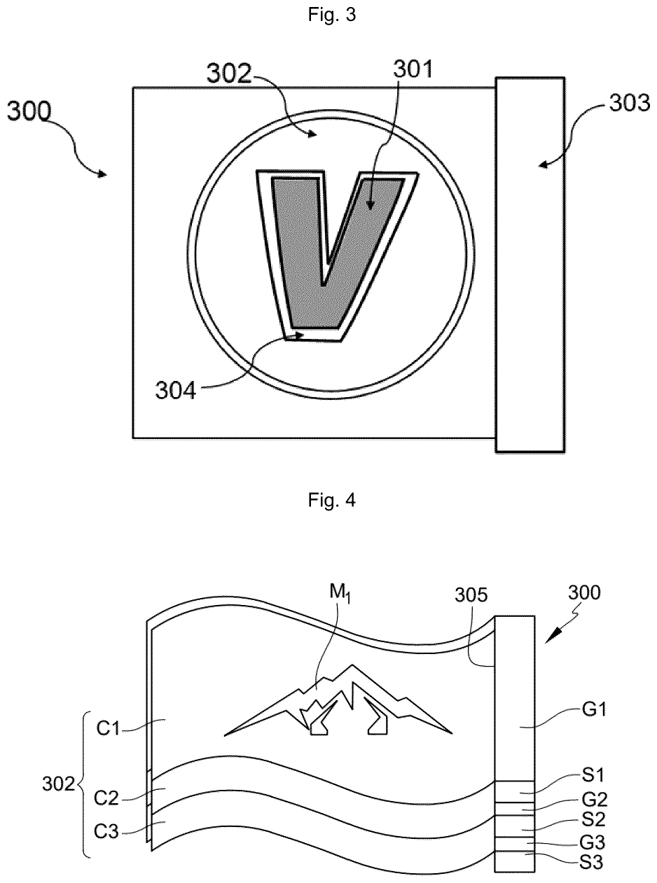

FIG. 3 illustrates an example of a decorative structure 300 comprising a raised pattern 301. The decorative structure 300 further comprises a transparent film or light guide 302.

The device 300 according to the invention further comprises a light source 303 suitable for injecting light into the waveguide 302.

The light guide 302 comprises a first layer of a transparent material into which one or more patterns 304 are etched. The patterns 304 are suitable for extracting the light propagating inside the guide 302. For this reason, the patterns 304 appear illuminated when the device 300 is illuminated.

In the example illustrated in FIG. 3, the raised pattern 301 is surrounded by the etched patterns 304.

According to another embodiment of the decorative structure 300, the decorative structure further comprises N other light guides and N other light sources. FIG. 4 illustrates the case with N=3.

Thus, with reference to FIG. 4, which shows another exemplary embodiment of a decorative structure 300, the latter in this case comprises a first light source S1, a second light source S2 and a third light source S3. The structure 300 further comprises a first light guide G1, a second light guide G2 and a third light guide G3. For example, the first light guide G1, the second light guide G2 and the third light guide G3 have a parallelepipedal shape.

The transparent film 302 is a multilayer structure, having a front face and a rear face, and comprising a first layer C1, a second layer C2 and a third layer C3. The first layer C1, the second layer C2 and the third layer C3 are superposed. The front face and the rear face are substantially parallel. The transparent film 302 is flexible. Typically, the thickness of the first layer C1, the second layer C2 and the third layer C3 is of the order of 50 microns.

The first layer C1 comprises first micro-etchings forming a first pattern M1. The second layer C2 comprises second micro-etchings forming a second pattern that is different from the first pattern M1. The third layer C3 comprises third micro-etchings forming a third pattern that is different from the first pattern M1 and from the second pattern M2. The second pattern and third pattern are not shown in FIG. 4.

Typically, the first micro-etchings, the second micro-etchings and the third micro-etchings are etched into the first layer C1, into the second layer C2 and into the third layer C3, respectively, using ultraviolet-radiation printing.

According to one embodiment, each of the N light guides has a different etched pattern. It is thus possible to illuminate each etched pattern independently with a different wavelength.

Each light source is suitable for injecting light into one of the light guides. According to one embodiment, the N light sources may emit in different spectral regions.

When light enters the first layer C1, only the portion of the first layer C1 comprising the first micro-etchings diffuses light, or in other words, is illuminated. When light enters the second layer C2, only the portion of the second layer C2 comprising the second micro-etchings diffuses light, or in other words, is illuminated. When light enters the third layer C3, only the portion of the third layer C3 comprising the third micro-etchings diffuses light, or in other words, is illuminated.

Each of the first layer C1, the second layer C2 and the third layer C3 can be made of polycarbonate, PMMA, PET (polyethylene terephthalate) or TPU (thermoplastic polyurethane). For example, the first layer C1, the second layer C2 and the third layer C3 may be components from Azumo™. These components have a transparency of more than 97%, a light extraction efficiency, when illuminated, of between 25 and 80%, and can have a luminance ranging from 100 to 1000 cd/² when illuminated by a source of luminous flux.

The transparent film 302 comprises a light entry face 305. The light entry face 305 is substantially perpendicular to the front face and to the rear face. For example, the light entry face 305 consists of one of the two lateral edges of the transparent film 302.

With reference to the example of FIG. 4, the first light guide G1, the second light guide G2 and the third light guide G3 are superposed. The first light guide G1, the second light guide G2 and the third light guide G3 also adjoin the light entry face 6, so as to ensure optical coupling with the light entry face 6. The first light guide G1 is juxtaposed with the first layer C1. The second light guide G2 is juxtaposed with the second layer C2. The third light guide G3 is juxtaposed with the third layer C3.

The first light source S1 is configured to emit a first light beam and is positioned such that the first beam illuminates the first light guide G1. For example, the first light source S1 is positioned facing one end of the first light guide G1.

The second light source S2 is configured to emit a second light beam and is positioned such that the second beam illuminates the second light guide G2. For example, the second light source S2 is positioned facing one end of the second light guide G2.

The third light source S3 is configured to emit a third light beam and is positioned such that the third light beam illuminates the third light guide G3. For example, the third light source S3 is positioned facing one end of the third light guide G3.

What is claimed is:

1. A method for manufacturing a raised pattern with a transparent film suitable for guiding light, the transparent film includes a first layer of a first transparent material, the method comprising:
etching, into the first layer of transparent material, a pattern suitable for extracting the light guided inside the transparent film,
forming the raised pattern in a zone of the transparent film.

2. The method as claimed in claim 1, wherein the raised pattern is a logo.

3. The method as claimed in claim 1, wherein forming the raised pattern includes three-dimensionally forming the transparent film.

4. The method as claimed in claim 3, wherein three-dimensionally forming the transparent film includes thermoforming process.

5. The method as claimed in claim 1, wherein forming the raised pattern is carried out by pressing on the transparent film.

6. The method as claimed in claim 1, further comprising producing reference marks in the transparent film, the reference marks being configured to position the pattern suitable for extracting the light with respect to the raised pattern.

7. The method as claimed in claim 1, wherein the transparent film includes an integer number greater than or equal to 1 of layers of transparent material superposed with the first layer of the first transparent material, the method further comprising etching at least one other pattern into at least one of the N layers of transparent material, and exposing and/or polymerizing the transparent film.

8. (canceled)

9. A decorative structure that can be illuminated, comprising:
a raised pattern;
a light guide comprising a first layer of a transparent material;
a light source for illuminating the light guide;
the light guide being positioned so as to guide rays originating from the light source into the first layer of transparent material and to illuminate an etched pattern.

10. The decorative structure as claimed in claim 9, further comprising:
N other light guides,
N other light sources for illuminating each of the N light guides, the N light sources emitting in different spectral regions, the N other light guides being positioned so as to guide rays originating from one of the N other light sources into a corresponding layer from among N layers of transparent material and to illuminate at least one other pattern.
